(19) United States
(12) Patent Application Publication
(10) Pub. No.: US 2025/0241350 A1
(43) Pub. Date: Jul. 31, 2025

(54) Integrated Closed Loop Agricultural Manufacture Specializing in the Production of Non-Centrifugal (Unrefined) Cane Syrup

(71) Applicant: Marie-Antoinette Francoise JEAN, West New York, NJ (US)

(72) Inventor: Marie-Antoinette Francoise JEAN, West New York, NJ (US)

(21) Appl. No.: 18/918,014

(22) Filed: Oct. 16, 2024

Related U.S. Application Data
(60) Provisional application No. 63/625,725, filed on Jan. 26, 2024.

(51) Int. Cl. A23N 1/00; A23N 15/00

(52) U.S. Cl. CPC A23N 1/00; A23N 15/00

(57) ABSTRACT

A modular and scalable sugarcane processing plant comprising a bagasse gasifier configured to receive bagasse from a sugarcane juice extraction process and produce a consumable gas, a sugarcane syrup production segment with a rated processing capacity defining a corresponding heat energy requirement, and a central heating plant configured to extract heat energy from the consumable gas. The heat energy output capacity of the central heating plant is matched to the heat energy requirement of the syrup production segment, enabling the bagasse gasifier and central heating plant to supply sufficient energy to drive the syrup production using solely the consumable gas produced from the bagasse. The invention enables the production of sugarcane syrup in a climate-resilient, sustainable and non-polluting manner. The practice of the invention results in a sugarcane product in a liquid form with range in syrup hues and flavors of intensity, relatively higher nutrient density and relatively low glycemic index and low glycemic load, with full-bodied flavor options, ranging from deep molasses to lighter.

### BACKGROUND OF THE INVENTION

### Field of Invention

The present disclosure relates to the field of sugarcane juice processing from sugarcane and, more particularly, to replicable standardize modular and scalable equipment packages for sugar cane processing. The micro sugar and energy plants utilize bagasse gasification for energy production. It also pertains to the products produced by the inventive systems and methods.

### Description of Prior Art

An example of the prior art is EP3827672, which discloses a method of preparing an extract from sugarcane bagasse or sugarcane straw comprising: obtaining a dried sugarcane bagasse or a dried sugarcane straw; milling the dried bagasse or the dried straw; mixing the milled bagasse or straw with a solution comprising a solvent to form a mixture; stirring the mixture; separating liquid fraction and solid fraction of the mixture; concentrating the liquid fraction to obtain an extract; optionally drying the liquid fraction to obtain a dry extract.

Another example is U.S. Pat. No. 11,730,178 which describes a process for producing an extract derived from sugarcane, the process comprising: i) mixing a sugarcane derived product with ethanol to produce an extraction mixture comprising at least about 50% v/v ethanol; ii) allowing a precipitate to form in the extraction mixture; iii) removing the precipitate from the extraction mixture to obtain a supernatant; and iv) removing ethanol from the supernatant to produce the extract derived from sugarcane.

The prior art describes processes in conventional sugarcane processing plants. Conventional sugarcane processing plants are typically large, energy-intensive industrial facilities that source sugarcane regionally. These plants often rely on a combination of fossil fuels and sugar cane bagasse for their energy supply, which can have a significant environmental impact. The scale and environmental footprint of such facilities can pose challenges for producers of consumable sugar products, as the associated costs may hinder commercial viability.

Moreover, the operation of traditional sugarcane processing plants requires substantial amounts of external energy, which may not be consistently available in certain geographical locations. Energy is consumed throughout the process, including for conditioning the sugarcane, filtering, evaporating, and drying the final sugar product.

Existing sugarcane processing solutions face certain limitations in terms of energy efficiency, environmental sustainability and scalability due to the massive size and complexity of standardized multiple effect evaporators. These traditional sugar refinery plants often result in higher operational costs and high skilled labor force. The present invention method produces a healthier sweetener by retaining essential nutrients, avoiding chemical bleaching, not using a centrifugal process, as well as offering a modular design making it accessible for small-medium enterprises. The present invention provides novel solutions to these limitations and differs from the prior art in that it can operate in a more climate-resilient and non-polluting manner, while being adaptable to various scales of production. A key difference is that the present invention utilizes pellets from bagasse to create gasification for energy production.

It is noted that traditional industrial sugar refineries have not utilized equipment that is used in maple syrup production because the volume output via the use of traditional maple syrup production technology would be too low in comparison. The production, in its traditional practice, would not be able to meet the demands of large-scale commercial sugar production levels. The foregoing is notable with the knowledge that maple syrup systems are traditionally designed for small-batch, artisanal production, which contrast with the continuous, high-throughput operations of conventional sugar plants that require massive evaporators, centrifuges, and crystallization units to process thousands of tons of sugarcane at a time. In contrast, the current invention micro plant is designed for batch production approach which allows for more flexible customization of evaporated cane juice also known as liquid syrup production. This modular design not only facilitates low-skill workforce involvement but provides opportunities for upskilling. The invention is a commitment to sustainability and efficient energy use, A key differentiator is the containerized CHP units gasifier systems. These compact, modular units allow for flexible, easy installation and scalability, accommodating various site sizes and enabling rapid deployment. This ensures that the invention of micro sugar and energy plants can be easily integrated into diverse environments, unlike the fixed, large-scale infrastructure of traditional refineries. The containerized CHP units primarily utilize bagasse pellets, adaptable to other forms of biomass like coconut shells, and wood chip pulp. These fuels are climate-resilient, offering carbon neutral, low ash content, and high energy density. The use of a pelletizer ensures that these pellets are reliable and easy to transport, facilitating seamless, efficient energy production. This form of energy production eliminates the need for fossil fuels, which are traditionally used in both sugar refineries and maple sugaring facilities.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

In one aspect, the present invention provides a modular and scalable sugarcane processing plant that utilizes pellets from bagasse to create gasification for energy production. The plant comprises a pellet bagasse gasifier configured to receive bagasse from a sugarcane juice extraction process and produce a consumable gas, a sugarcane syrup production segment with a rated processing capacity that defines a corresponding heat energy requirement, and a central heating plant configured to extract beat energy from the consumable gas produced by the pellet bagasse gasifier. The heat energy output capacity of the central heating plant is matched to the heat energy requirement of the sugarcane syrup production segment, enabling the pellet bagasse gasifier and central heating plant to supply sufficient energy to drive the syrup production using solely the consumable gas produced from the bagasse.

In embodiments of the present invention, a combined heat and power (CHP) configuration can be used for the simultaneous generation of useful heat and electricity from the pellet bagasse. Pellet fuel can be produced from the bagasse.

In a preferred embodiment, the sugarcane syrup production segment includes a cane crushing system for extracting sugar cane juice and outputting bagasse, bagasse into a pelletizer system for fuel into the gasifier system, a filtration system for removing impurities from the extracted juice, and a vacuum boiling system for concentrating the filtered juice into syrup. The plant may further comprise a UV reverse osmosis system powered by the central heating plant for separating water from the filtered juice to produce a concentrated sugar water juice, and a refrigerated silo with agitators for storing the concentrated juice.

Advantageously, the modular and scalable sugarcane processing plant may include a bagasse dryer that utilizes heat recovered from the central heating plant to dry the bagasse from the cane crushing system, and a pelletizer for compressing the dried bagasse into fuel pellets for the bagasse gasifier. The central heating plant may further comprise a heat transfer fluid boiler for heating a heat transfer fluid using heat from the consumable gas, and a heat exchanger for transferring heat from the heated fluid to the syrup production segment.

In general, one inventive aspect of the present inventive system is its scalability and configurability. As configured as a micro-plant, the inventive system can support a modular, batch-based and customized production process. The flexibility serves as an alternative to the traditional industrial-scale sugar refining model. Unlike conventional sugar refineries, which operate as large, continuous-processing plants requiring high-capacity throughput and significant energy consumption, the present inventive system can utilize independent evaporator lines that function as silos, allowing for flexible, small-batch production based on available volumes of concentrated cane juice. This being the case, the inventive system eliminates the inefficiencies of traditional sugar plants, where an entire facility must be in operation at once, even when processing lower volumes. The maple sugaring industry relies heavily on Reverse Osmosis (RO) to concentrate sugar levels due to the low sugar level of the maple water. The present invention system leverages RO technology to increase the sugar content to double or triple, e.g., taking it from 15 Brix to 35 Brix, effectively reducing processing time. This process separates the sugar concentrate from the water, achieving up to a 54% water separation. This significantly decreases the need for water usage, making the process less water-intensive micro plant operation. The extracted water can be repurposed for equipment cleaning or remineralization for agricultural use or drinking, supporting sustainable practices.

The present invention also provides a method for producing cane sugar syrup in a climate-resilient and non-polluting manner. The method involves extracting sugar cane juice and bagasse from unprocessed sugar cane, gasifying the bagasse to produce a consumable gas, processing the juice in a syrup production segment having an energy requirement, extracting heat energy from the consumable gas in a central heating plant, and supplying the extracted heat energy to the syrup production segment to meet its energy requirement. The energy supplied by the consumable gas from the bagasse is sufficient to meet the energy requirement of the syrup production segment.

The results of practicing an embodiment of the inventive method or utilizing an embodiment of the inventive system are products with characteristics and natures that are defined directly by the steps of the inventive methods, the elements of the inventive systems or both.

The foregoing and other features and advantages of the invention will be apparent from the following more particular description of preferred embodiments of the invention. The present disclosure addresses the need for improved sugar cane processing systems that can operate efficiently and sustainably, while being adaptable to various scales of production. By integrating bagasse gasification and a central heating plant matched to the energy requirements of the syrup production segment, the modular and scalable plant design of the present invention solves the problems associated with conventional sugar cane processing facilities, such as reliance on fossil fuels and limited scalability. The invention enables the production of cane sugar syrup in a climate-resilient and non-polluting manner, with the potential for significant cost savings and environmental benefits compared to traditional approaches.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 depicts a flow chart detailing an embodiment of the steps for the transformation of raw sugar cane into high-quality syrup

FIG. 2 is a subsystem diagram for an organic cane syrup processing plant.

FIG. 3 is an organic CHP electrical plant and sugar processing plant diagram.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems and methods described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

The present invention can provide a more environmentally friendly sugar production process. In one exemplary embodiment, the system can condition and use process byproducts such as conditioned bagasse as a primary energy source for producing liquid sweeteners and sugarcane syrup.

In this embodiment, a Combined Heat and Power (CHP) electrical power plant is able to use conditioned byproducts (e.g., bagasse) as fuel. Where the sugarcane treatment plant capacity is sized according to the electrical power available from the CHP, the system's energy production can closely match the processing energy demands. In one approach to matching the plant capacity to the CHP energy production, the equipment is sized to insure that the daily harvest approximates the daily consumption. In one approach, where the matching is of daily or even shorter duration, the process can approximate a continuous flow processing capability. In effect, if the daily energy production matches the daily consumption, the need for extensive material or energy storage can be reduced or even eliminated.

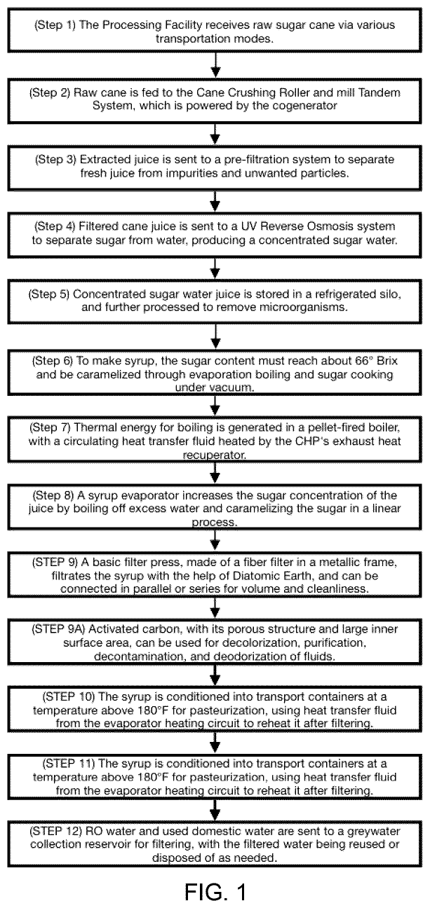

FIG. 1 depicts a flow chart detailing an embodiment of the steps for the transformation of raw sugar cane into high-quality syrup.

(Step 1) In one embodiment, the Processing Facility receives material in the form of raw sugar cane at a receiving dock or similar structure. The raw sugar cane may arrive via truck, train, barge, or other conventional transportation mode.

(Step 2) According to an embodiment, the raw cane is fed to a Cane Crushing Roller and mill Tandem System as its input. The cane crushing system also receives energy input from the cogenerator that is fueled by bagasse pellets. Cane crushers are typically powered by electrical energy. In some embodiments, within the cane crushing system, when raw cane is fed into the rolling crushing mills, cane juice is extracted from the cane. The process comprises a few stages, including a shredder configured to shred the stalk, grooved rollers to press the shredded stalk, and a series of individual mills disposed in a uniformed tandem milling arrangement for efficiency to extract maximum juice.

In one embodiment, all cane conditioning and juice-extracting operations are mechanical operations. Mechanical power can be obtained from internal combustion engines, steam engines, or electrical motors. For ease of operation and equipment supply, electrical motors are preferred. In another embodiment, the CHP bagasse-fired plant must be sized such that its electrical power generation capacity exceeds the total sugar cane processing plant electrical needs by about 25%.

(Step 2A) In some embodiments, the bagasse dryer and conditioning system receives the shredded stalk. The shredded bagasse or stalk is dried in a tumbler to prepare it to be compressed in the pelletizer. Once processed, sugar cane stalk moisture content is above 50%, thereby eliminating all heating values from the bagasse. The processed sugar cane stalks are passed through a rotary dryer, wherein an incoming mixture of warm air, gasifier exhaust, producer gas-fired electrical generator's engine, and boiler exhaust gases provide drying heat for the bagasse. Recovering otherwise lost low-grade heat to dry bagasse rather than using a gas-fired rotary dryer improved the overall sugar cane processing plant.

(Step 2B) According to an embodiment, the pelletizer is a machine configured to compress the shredded bagasse into pellets that are consistent in size, shape, and weight for the purposes of fuel source. The plant uses the bagasse as biomass fuel to eliminate the cost and reliance on fossil fuels. As we know it today, fossil fuels are proven to intensify environmental pollution that continues to harm the Earth. While the pellet pressing system helps to solve environmental negative impact problems, biomass pellets are a clean source of energy. In one embodiment, shredded bagasse is first dried in a kiln; low-temperature warm air recovered from the CHP plant and the evaporator's boiler, which would otherwise be lost to the atmosphere, is ducted to the drying kiln. Dried bagasse is then processed into pellets by the pelletizer. The pellets are then directed to the CHP fuel bunker or to storage for the black start of the plant.

(Step 2C) In some embodiments, the CHP and boiler operate on producer gas. Producer gas is a mixture of carbon monoxide (CO) and hydrogen (H2) that can be used to fuel internal combustion engines and boilers' burners. A gasifier is used for that process. Pellets are fed into a reactor where partial combustion under a low-oxygen atmosphere occurs. Carbon monoxide and hydrogen are generated, filtered, compressed, and then piped to the CHP combustion engine and boilers. Generated heat from the reactor is used for bagasse drying.

(Step 20) According to an embodiment, a cooling tower is a specialized heat exchanger that takes in air and water, which are brought into direct contact with each other to reduce the water's temperature. When this occurs, a small volume of water is evaporated, thereby reducing the temperature of the water being circulated through the tower.

In one embodiment, the water, which enters after being heated by an industrial process, is pumped into the cooling tower. The water goes through a series of nozzles, reducing the temperature. As the water flows through the cooling tower, it is exposed to air, which is being pulled through the tower by the electric motor-driven fan.

In some embodiments, when the water and air meet, a small amount of water is evaporated, creating a cooling action. The cooled water is then pumped back to the condenser or process equipment where it absorbs heat. It will then be pumped back to the cooling tower to be cooled once again. Cooling Tower Fundamentals provides a level of basic cooling.

(STEP 2E) In one embodiment, electrical power is generated by producer-gas-fueled internal combustion engines' electrical generators. The heat from the exhaust is recovered for further use in evaporating the sugar cane concentrate. The heat from the combustion engine cooling is recovered for use in the bagasse drying process.

In another embodiment, the electrical generator output must be sized to ensure about 125% of the total electrical needs of the sugar plant.

(Step 3) According to an embodiment, once the juice is extracted, it is sent into a pre-filtration system that separates fresh juice from impurities and all unwanted floating particles. The pre-filtration system is also powered by the cogeneration system. A low-pressure electrical pump forces the juice through a battery filter to remove impurities. The filtered juice is stored in a settling tank.

(Step 4) In some embodiments, filtered fresh cane juice is sent into a UV Reverse Osmosis system that separates the sugar from water to produce a concentrated sugar water juice, thereby reducing the evaporation time to produce syrup or sugar and thus reducing the need for energy. The water that was separated from the sugar juice flows into a basin to be reused throughout the plant. The UV Reverse Osmosis system is powered by the cogeneration system. Reversed osmosis (RO) is achieved by using a specialized membrane that, when a pressure differential is applied between the membrane faces, only water will pass through. By removing water, the sugar concentration of the juice is increased. RO is the most energy-efficient way of increasing the sugar content of a solution. Electrically powered high-pressure pumps are used to generate the pressure differential required for the RO to occur.

(Step 5) According to an embodiment, the concentrated sugar water juice is sent into a refrigerated silo with agitators to be discharged when ready to use. The refrigerators are powered by the cogeneration system. The concentrated juice is further processed through an electrically powered micro-filtration unit. Micro-filtration removes all microorganisms like yeast and bacteria, thereby preventing concentrate juice degradation. Alternatively, pasteurization could also be used for the same purpose.

(Step 6) In one embodiment, to make syrup, the sugar content of the final product must be about 66.7° at the Brix scale, and the sugars produces molasses. The process includes a rise in sugar concentration by evaporation boiling and sugar cooking. The color and taste are developed through that process. In another embodiment, the typical RO process will increase the sugar content to about 35° at the Brix scale typically from a starting Brix average of 10-16 Brix; further rise in Brix must be accomplished by evaporation. Boiling under a vacuum allows for a lower boiling temperature. In turn, boiling at a lower temperature provides a syrup with less color and taste.

In some embodiments, the concentrate is admitted in a closed container under vacuum. The vacuum is maintained by an electrically driven vacuum pump, and heat for boiling is provided from a remote heat transfer fluid boiler. The heat transfer fluid is circulated from the boiler to the container's heat exchanger.

(STEP 7) According to an embodiment, thermal energy required for boiling is generated in a pellet-fired boiler. A circulating heat transfer fluid is first heated by the CHP's internal combustion engine exhaust heat recuperator, and then the final heat transfer fluid's required temperature is reached at the boiler. Thermal energy is spent by boiling the juice and cooking the sugar. The heat transfer fluid returns to the CHP's engine.

In one embodiment, the boiler is a standard ASME heat transfer fluid boiler, wherein the fossil fuel burner is replaced by a pellet burner.

(STEP 8) In some embodiments, a syrup evaporator's purpose is to increase the sugar concentration of the juice by boiling off excess water and caramelizing (cooking) the sugar. The syrup-making process is linear; concentrate enters at one end, travels through heat exchangers, loses water, and gains internal thermal energy. Sugar cooking occurs, and the syrup exits at the other end.)

In one embodiment, a vertical evaporator is made of a cylindrical body with heat exchangers mounted inside the cylinder volume. Fresh concentrate is admitted at the top. As water is evaporated, concentrate density increases, forcing the concentrate downward. Traveling down, losing more water, and increasing internal heat causes cooking of the sugar. The syrup is retrieved at the bottom of the cylindrical evaporator.

(STEP 9) According to an embodiment, a basic filter press is made of a fiber filter maintained in place by a metallic frame. Syrup to be filtrated is pumped by an electric pump through the filter. Diatomaceous Earth (DE) also known as a filter aide is mixed with the hot syrup once drawn off from the evaporator. It is mixed by hand and/or with an automatic mixing paddle to be evenly distributed with the syrup. The DE helps the syrup to flow through the filter press to ease the pressure of flow, but most importantly to give a quality finished syrup by removing any unwanted partials. In one preferred embodiment, the finishing syrup process calls for the use of Diatomaceous earth (DE). In addition, when customizing syrup batch production, to maintain health properties but manipulate the color, smell or taste profile, the use of activated carbon charcoal is required. DE is mixed with the hot syrup ahead of the filter press to facilitate the process by providing voids where debris can be deposited. To provide more volume, several basic filter presses are connected in parallel. To provide cleaner syrup, several basic filter presses are connected in series.

(STEP 9A) In one embodiment, activated carbon is an inert product made of carbon having a porous structure with considerable inner surface area. For example, some inner surface measures are in the range of about 700-2000 m2/g. Activated carbon can thus trap unwanted molecules present in liquids and gases in its pores by adsorption.

In another embodiment, activated carbon may be used in decolorization, purification, decontamination, and deodorization of a wide range of fluids. Three forms are typical: powdered, granular, and pellet. Activated carbon charcoal is also widely used in the food and beverage industry to eliminate color, odor, and undesirable flavor. It also can stabilize the syrup to prevent mold, bacterial growth from fermentation and removal of contaminates. Pending the saturation time of activated charcoal carbon, its additional use allows for color gradation of the syrup. The various gradation of syrups also relates to the odor, color and finished flavor. The lighter the syrup the more absence of flavor of molasses.

(STEP 10) In some embodiments, the syrup must be conditioned into transport containers at a temperature above 180° F. to provide pasteurization. Since heat is lost in the filtering process, reheating the syrup above 180° F. is needed. Heat transfer fluid from the evaporator heating circuit is used for that purpose.

(STEP 11) According to an embodiment, the syrup must be conditioned into transport containers at a temperature above 180° F. to provide pasteurization. Since heat is lost in the filtering process, reheating the syrup above 180° F. is needed. Heat transfer fluid from the evaporator heating circuit is used for that purpose.

(STEP 12) In one embodiment, a great quantity of cold and hot domestic water is required throughout the process. Fortunately, RO provides a large quantity of water. RO waters and used domestic waters are sent to a greywater collection reservoir where the greywater is filtered. Needed domestic water is pumped from that reservoir and heated as needed. Excess filtered water is disposed of.

One specific embodiment of the present method invention for the production of various unrefined cane syrup that maintains essential nutrients and minerals while also allowing for customizable pure cane syrups ranging in characteristics from clear to molasses measuring against ICUMSA (International Commission for Uniformity Methods of Sugar Analysis) colorimetric reader. This particular embodiment comprises in combination, for example, the steps of starting with (A) extracting sugarcane juice from fresh sugarcane using first cane crusher to macerate the sugar cane. The extracted juice is then (B) Ultra filtered—not by centrifugal process—to preserve the natural juice while removing impurities and retaining polyphenols, amino acids, and antioxidants (minerals and vitamins). It is also (C) treated with ultraviolet (UV) light with thin film reactor to eliminate bacteria, yeast and microbes without using chemical agents. (D) Always reverse osmosis is applied to separate water content and reduce evaporation time and energy consumption while concentrating natural sugars. Then (E) the concentrated juice (RO) is refrigerated for later evaporation. When ready, (F) the concentrated juice (RO) is evaporated using one of three distinct evaporation methods, each producing unique syrup characteristics: (i) open flat pan evaporator, (ii) enclosed steam evaporator, or (iii) low pressure vacuum boiler.

The open flat pan evaporator, which can be powered by bagasse pellets, (i) requires continuous monitoring and designed with direct heat exposure onto the flat, allowing for deeper flavor development from the caramelization of sugar as evaporation progresses. Ideal for the production of molasses rich syrups and/or syrup with more caramelization characteristics such as 70+ Brix for traditional molasses—creating a rich, full-bodied syrup with deep color and robust flavor. Ideal for traditional and artisanal syrup-making, preserving the intense natural complexity of sugarcane flavors.

The steam evaporator (ii) is an enclosed unit that accelerates production through precise thermal control. It functions as a hybrid method, combining elements of both vacuum and open pan evaporation. Controlled steam heat is used to accelerate evaporation while partially caramelizing sugars. This element produces a medium-bodied syrup with a balance of color, viscosity, and caramelized notes, offering a range between light and molasses-type syrups, but faster volume production.

The vacuum boiler operates at lower temperature than traditional evaporators, maintaining 185° F., using reduced atmospheric pressure to gently remove water from the syrup and allows for (a) high density while preserving sugar characteristics and (b) prevention of scorching the pans or over cooking process. It thus maintains a delicate sugarcane flavor, producing clear syrups with a light, mild taste with the ability to control Brix level compared to molasses-based syrups.

After evaporation, (G) various filter aids are used with charcoal carbon and diatomaceous earth to achieve various color and purity levels without the use of bleaching agents. This step results in the selective reduction of color and odor intensity with flavor depth maintained, and through which a range of syrup profiles are enabled.

The inventive method also includes (H) adjusting Brix levels and density for final consistency by employing a recalibrating system and (I) ensuring batch consistency through routine quality control, calibration, and inspection before each production run. Further, (J) the final syrup is pasteurized above 180° F. and hot-packed using a closed-loop heating system to prevent microbial growth without altering its natural composition or high pressure processing (HPP). Following the foregoing, (K) the final syrup is air tight sealed for any and all appropriate packaging vessels and then stored in temperature-controlled silos to maintain freshness and extend shelf life. The final syrup product is preferably bottled to ensure retention of natural properties without the use of artificial additives. Within the steps, (L) a combined heat and power (CHP) system powered by biomass-derived bagasse (biomass) pellets is used to produce energy to sustain plant operations.

In certain embodiments of the present invention of HPP, at the final stage of syrup production, is a key step. The HPP step is distinguishable from traditional heat-based and chemically preserved syrup processing. For one, HPP ensures microbial safety, extended shelf stability, and the preservation of natural nutrients. Unlike and as opposed to traditional and conventional sugar refineries that rely on industrial-scale refining, bleaching, crystallization chemical preservatives or high-heat pasteurization (or combinations of the foregoing)—which can degrade the integrity of natural cane syrup, HPP uses cold, high-pressure technology to eliminate bacteria, mold, and microbes without altering the syrup's natural composition. This step of preferred embodiments retains the full nutritional profile of unrefined sugarcane, ensuring that the syrup remains chemical-free, shelf-stable, and rich in naturally occurring minerals. In addition, by combining batch-based quality control, renewable energy, and advanced food safety technology, embodiments of the present inventive system redefine sugar manufacturing for the modern, health-conscious consumer while maintaining the highest standards of sustainability and purity. Further, the present inventive system, with the HPP step, supports a scalable, energy-efficient alternative to centralized sugar refining, allowing for adaptive production cycles that respond to market demands, seasonal cane availability, and operational efficiency requirements.

In some embodiments, the cane crushing system includes a syrup output and a bagasse output. As the cane is crushed, sugar syrup is released and extracted. The sugar syrup gathers in a lower catch basin and exits via a syrup output. While the figure shows this generally, for clarity of presentation, some of the known subsystems, such as filters, valves, pumps, or other implementation details, are not included. One skilled in the art would implement such components and subsystems according to the general system design. For example, coarse filter size, aperture sizes, catch basin size, and angle of gravity feed would be design choices that depend on the target system capacity, characteristics of the input material, and other known considerations.

According to an embodiment, the cane crushing system also includes a bagasse channel. The bagasse channel outputs the remaining material, much of which is crushed fibrous remnants of the input sugar cane.

In one embodiment, a bagasse dryer receives the output bagasse material from the cane crushing system via the bagasse output channel. There, moisture and other undesirable materials are removed. Bagasse drying and conditioning (pelletized) energy is provided by the CHP.

In some embodiments, CHP is fueled by bagasse pellets, using a gasification process to tum bagasse pellets into gaseous fuel that supplies a spark ignition or diesel motor that, in turn, powers an electrical generator.

The Pellet fuel is the main power (energy) like the others use bagasse as raw material for fuel, but rather than using loose bagasse it goes through a pelletizer system. The pelletizer uses the raw material into homogeneous mass and then gets feed into a gasifier co-generator system to the boiler for steam and that steam recirculates back, as per the diagram.

According to an embodiment, either a bagasse pellet-fueled evaporator or a bagasse pellet-fueled boiler provides the thermal energy required to increase the sugar content of the sugarcane juice to the needed concentration.

In one embodiment, the sugarcane sweetener process uses vacuum boiling to prevent sugar cooking by keeping a low boiling temperature.

In some embodiments, the process described herein may be used to produce various types of syrups with different characteristics by adjusting process parameters. By way of example and not limitation, the concentration of sugar in the final syrup product, known as the brix level, can optionally be varied to produce syrups of different sweetness.

The amount of molasses included might be adjusted to control the color and flavor profile of the syrup. Characteristics such as aroma and viscosity can also generally be customized for different applications by modifying factors including but not limited to the cooking temperature and time in the evaporator.

By altering these parameters, this process may be used to manufacture syrups to different specifications, ranging from light-colored and mild-flavored to dark, strongly-flavored, and substantially more viscous. This flexibility allows the production of syrups tailored for various uses, such as table syrups, cooking ingredients, or industrial sweeteners.

The chemical makeup of the process can include low GL (glycemic load) compositions.

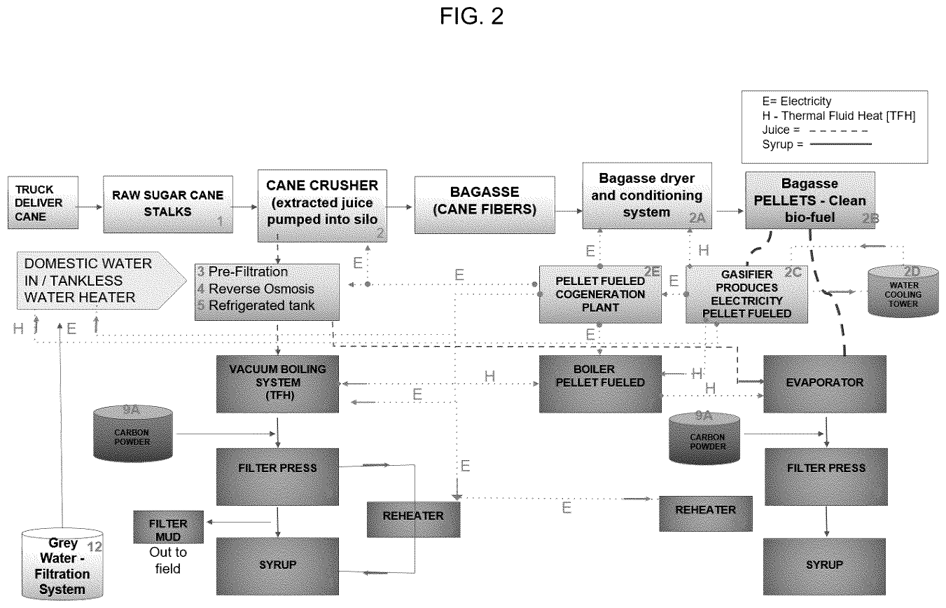

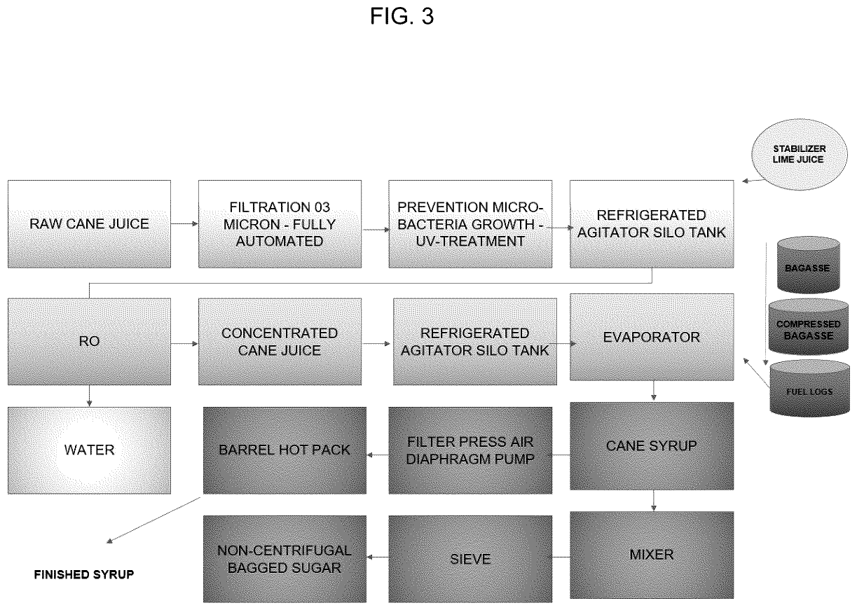

In embodiments of the present invention, FIG. 2 is a subsystem diagram for an organic cane syrup processing plant, and FIG. 3 is an organic CHP electrical plant and sugar processing plant diagram.

One specific embodiment of the present inventive system producing various unrefined cane syrup in a modular takes the form of a scalable sugarcane processing plant that is powered by renewable bio-mass energy. This particular embodiment is designed to create customizable pure cane syrups ranging in color hue from translucent clear non-centrifugal syrup to dark robust molasses, clear, pale yellow, golden, amber and dark brown. Its elements include, for example, (A) a non-centrifugal juice extraction system, which can preserve essential minerals and nutrients, (B) a filtration system for removing impurities, while retaining natural sugarcane compounds; (C) a UV light with thin film reactor to prevent yeast, bacteria growth or fermentation of cane juice, (D) a reverse osmosis unit to concentrate sugar while reducing evaporation time and energy consumption, and (E) a selected use evaporator system.

The method used by the evaporator determines the final syrup characteristics as customization. The evaporator element itself preferably includes (i) a vacuum boiling system at 185° F. for clear syrups with no caramelization (producing light-colored, mild-flavored syrup), (ii) a flat pan (open pan) evaporator for molasses production exceeding 70+ Brix, creating a deeply caramelized, full-bodied syrup, and (iii) a steam evaporator as a hybrid system, achieving controlled caramelization for medium-bodied syrups and higher volume production

The system set forth immediately above also preferably includes (F) a natural filtration system utilizing activated charcoal carbon and diatomaceous earth to modify color, odor, and flavor intensity post-evaporation; for quality and purity, (G) a recalibrating unit for adjusting syrup density and consistency, (H) a quality control monitoring system ensuring uniformity across batches through routine calibration and inspection, (I) a closed-loop pasteurization system ensuring microbial stability without chemical preservatives, (J) a refrigerated storage system to maintain the syrups integrity and extend shelf life, (K) a combined heat and power (CHP) energy system utilizing biomass from bagasse or coconut shell pellets to generate electricity and thermal energy; with a generator and an Organic Rankine Cycle (ORC) system that recycle waste heat energy back to the generator for efficient energy production. (L) a packaging system that preserves syrup integrity without synthetic additives or excessive processing.

A product produced by the inventive systems and method retains its natural mineral and vitamins content due to the absence of centrifugal separation, high temperature heat and chemical bleaching. The syrups evaporation process used to produce such products is customized and allows (i) clear syrup production at 185° F. using a vacuum boiling system, preventing caramelization while maintaining a mild, delicate flavor, (ii) molasses formation exceeding 70 Brix using a flat pan (open pan) evaporator, producing a rich, deeply caramelized syrup, and (iii) balanced syrup production using a steam evaporator, creating a hybrid syrup with medium caramelization. Further, product (i) has a color and odor intensity are selectively reduced through activated charcoal filtration, allowing for a range of syrup variations from dark molasses to lighter, refined syrups; (ii) maintains a low glycemic load and glycemic index, making it a healthier alternative to refined sugars and high-fructose corn syrup; and (iii) is storable in temperature-controlled silos to ensure freshness and prevent crystallization.

One of ordinary skill in the art would recognize that the scalability of the present invention—both as methods and as systems—allows for, for example: (a) individualized evaporator lines to be operated independently or simultaneously, depending on production needs; (b) batch-controlled processing, enabling quality consistency while optimizing energy use; and (c) decentralized deployment, reducing capital expenditure and logistical constraints compared to large-scale refineries. The independent evaporator lines and modular silos support configurability and batch control. As such, their use represents a different approach from the use of centralized, continuous sugar refinery models. In particular, with the integration of HPP at the final stage, the inventive methods and/or systems facilitate the production of shelf-stable, unrefined cane syrup without the use of industrial-scale refining, chemical additives, or excessive heat treatment. This approach can be a new standard for sustainable, small-footprint sugar processing, offering a disruptive alternative to traditional refining models while maintaining the flexibility and efficiency required for modern food production and global market adaptability.

The inventive methods and systems in some ways, through their novel methodologies and configurations, integrate maple syrup technology into sugarcane processing, allowing for unprecedented flexibility, ease of scalability, and operational simplicity. Unlike traditional refineries, which require specialized engineers and high-maintenance industrial equipment, the inventive system, for example: (a) utilizes multiple, independent evaporator lines that function like silos, allowing for batch-based production rather than requiring an entire facility to operate at once; (b) offers case of scalability, where additional lines can be brought online as needed to increase production capacity without the capital-intensive expansion required by large industrial plants; and (c) simplifies operations, making it accessible for upskilled workers rather than requiring specialized engineers, thereby reducing labor costs and expanding workforce accessibility.

By utilizing certain aspects of maple syrup technology for sugarcane evaporation, the present invention creates a more adaptable, energy-efficient, and modular processing system. As such, the barriers to entry are lowered for new market participants and sugar production can be deployed in regions where traditional industrial refineries are impractical or cost-prohibitive. The result is a highly customizable, decentralized approach to sugarcane processing that meets modern demands for sustainability, traceability, economic viability and healthier sweetener.

In comparison with the characteristic and attributes of the present invention, the prior art teaches and suggests, for example: (a) maple syrup is mostly water and sugar, while sugarcane juice contains high fibers and impurities that require robust equipment, and thus it would not be obvious to use maple syrup technology in the production of sugarcane; (b) sugarcane involves crushing and clarifying, and these steps are not required for maple syrup production, thus the use of equipment needed to handle the sugarcane load is not associated with maple syrup production; (c) maple syrup is boiled at lower temperatures, thus the thought of precise, higher temperature requirements of sugarcane syrup would not be immediately considered since maple syrup equipment is not designed for that level of support; (d) sugarcane processing is typically larger scale, industrial manufacturing and since maple syrup canning equipment is designed for smaller volume batches, the scaling up of such equipment is not suggested; (e) sugarcane's fibrous nature leaves more residue, demanding specialized cleaning protocols that is meaningfully different from cleaning protocols associated with the use of maple syrup equipment; (f) sugarcane juice has a different sugar composition, affecting crystallization differently than sap juice that becomes maple syrup; (g) sugarcane requires faster evaporation, that is not relevant in the production of maple syrup; (h) sugarcane's high volume and fiber demand require sturdier equipment, while maple syrup equipment is not as robust; (i) noting that different industries have unique regulatory standards, maple syrup equipment likely have different standards than sugarcane equipment; and (j) operators are trained for sugarcane-specific processes, which differ from maple syrup, accordingly, using maple syrup equipment requires retraining or adaptation.

More particularly, maple syrup evaporation typically occurs at lower temperature than sugarcane processing, around 219° F., because of the concentration from sap into syrup. For sugarcane, the juice is boiled at higher temperatures, often above 220° F., to crystallize the sugar. The rate depends on factors like equipment type, juice composition, and desired product. Typically, sugarcane processes are faster due to higher sugar content. sugarcane juice, temperatures can range from around 221° F. to 230° F., depending on the stage of evaporation and the equipment. The goal in the use of the present invention is to concentrate the juice until it thickens and forms sugar crystals. Different stages require slightly different temperatures, especially when refining the product.

Based on the detailed description provided herein, a skilled artisan would be able to re-create the claimed invention without undue experimentation. The examples herein describe the key aspects of the invention in sufficient detail to allow a person having ordinary skill in the field of sugar processing to make and use the invention.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A modular and scalable sugarcane and cane juice processing plant comprising:
a bagasse gasifier configured to receive bagasse from a sugarcane juice extraction process and to produce a consumable gas from the bagasse;
a sugarcane syrup production segment having a rated sugarcane processing capacity that defines a corresponding heat energy requirement; and
a central heating plant configured to extract heat energy from the consumable gas produced by the bagasse gasifier, the central heating plant having a heat energy output capacity matched to the heat energy requirement of the sugar cane syrup production segment;
wherein the bagasse gasifier and central heating plant are configured to supply sufficient energy to drive the sugar cane syrup production segment using solely the consumable gas produced from the bagasse; and
wherein the bagasse gasifier and central heating plant are configured to supply sufficient energy to drive the sugar cane syrup production segment using solely the consumable gas produced from the bagasse.

2. The modular and scalable cane sugar processing plant of claim 1, wherein the sugar cane syrup production segment comprises:
a cane crushing system configured to extract sugar cane juice from sugar cane and output bagasse;
a filtration system configured to remove impurities from the extracted sugar cane juice; and
a vacuum boiling system configured to concentrate the filtered sugar cane juice into sugar cane syrup.

3. The modular and scalable cane sugar processing plant of claim 2, further comprising a UV reverse osmosis system configured to separate water from the filtered sugarcane juice to produce a concentrated sugar water juice, wherein the UV reverse osmosis system is powered by the central heating plant. The concentrated juice reduced evaporation time and reduce energy consumption. The separation of water to concentrate further claims climate resiliency and sustainability with the upcycle of water as use of clean water for cleaning.

4. The modular and scalable sugarcane processing plant of claim 2, further comprising a refrigerated silo with agitators configured to store the concentrated sugar water juice, wherein the refrigerated silo is powered by the central heating plant.

5. The modular and scalable sugarcane processing plant of claim 1, further comprising a bagasse dryer configured to receive the bagasse from the cane crushing system and to dry the bagasse using heat recovered from the central heating plant.

6. The modular and scalable cane sugar processing plant of claim 5, further comprising a pelletizer configured to compress the dried bagasse into fuel pellets for the bagasse gasifier, wherein the is not limited to matching the energy production to the rest of the system.

7. The modular and scalable sugarcane processing plant of claim 1, wherein the central heating plant further comprises:
a heat transfer fluid boiler configured to heat a heat transfer fluid using heat from the consumable gas; and
a heat exchanger configured to transfer heat from the heated heat transfer fluid to the sugar cane syrup production segment.

8. The modular and scalable sugarcane processing plant of claim 1, further comprising a water cooling tower configured to cool water heated by the sugar cane syrup production segment for reuse.

9. The modular and scalable sugarcane processing plant of claim 2, further comprising a reheater configured to heat the sugarcane syrup above 180° F. for pasteurization using heat transfer fluid from the vacuum boiling system.

10. The modular and scalable sugarcane processing plant of claim 1, further comprising a recirculating water filtration system configured to filter water from the sugarcane syrup production segment for reuse as domestic water in the plant.

11. A method for producing sugarcane syrup in a climate-resilient and non-polluting manner, the method comprising:
extracting sugarcane juice and bagasse from unprocessed sugarcane in a juice extraction step;
gasifying the pellet bagasse in a bagasse gasifier to produce a consumable gas;
processing the sugarcane juice in a sugarcane syrup production segment to produce a sugarcane syrup, the syrup production segment evaporation having an energy requirement;
extracting heat energy from the consumable gas in a central heating plant; and
supplying the heat energy extracted from the consumable gas to the sugar cane syrup production segment to meet the energy requirement thereof;
wherein the energy supplied by the consumable gas from the bagasse is sufficient to meet the energy requirement of the sugarcane syrup production segment.

12. The method of claim 11, wherein the bagasse gasifier comprises a reactor configured for partial combustion of the bagasse under a low-oxygen atmosphere to generate a mixture of carbon monoxide and hydrogen.

13. The method of claim 12, further comprising filtering, compressing, and piping the mixture of carbon monoxide and hydrogen to a combustion engine and boiler of the central heating plant.

14. The method of claim 11, wherein the central heating plant comprises:
a beat recuperator configured to extract a first portion of the heat energy from an exhaust of an internal combustion engine; and
a boiler configured to extract a second portion of the heat energy from the consumable gas to heat a heat transfer fluid circulated to the sugar cane syrup production segment.

15. The method of claim 11, wherein extracting the sugarcane juice comprises:
crushing the unprocessed sugar cane in a series of cane crushing mills to release the sugarcane juice; and
collecting the sugarcane juice in a catch basin.

16. The method of claim 15, further comprising filtering the sugarcane juice to remove impurities and produce a filtered sugarcane juice.

17. The method of claim 16, further comprising concentrating the filtered sugar cane juice by reverse osmosis to produce a concentrated sugarcane juice.

18. The method of claim 17, further comprising:
storing the concentrated sugarcane juice in a refrigerated silo; and
filtering the concentrated sugarcane juice through multiple a micro-filtration unit to remove microorganisms.

19. The method of claim 18, wherein processing the sugar cane juice to produce the sugarcane syrup comprises:
boiling the concentrated sugarcane juice under vacuum in an evaporator to evaporate water until the sugar produces molasses or simply sugar to produce the sugarcane syrup; and
filtering the sugarcane syrup through a filter press with the addition of DE diatomaceous earth and pending the type of needed syrup or sugar the addition of activated charcoal carbon.

20. The method of claim 19, further comprising reheating the sugarcane syrup above 180° F. using the heat transfer fluid from the evaporator to the draw off tank to pasteurize the cane sugar syrup to prevent bacterial growth prior to packaging.

21. A system for producing various unrefined cane syrup in a modular, scalable sugarcane processing plant comprising:
a non-centrifugal juice extraction system, which can preserve essential minerals and nutrients,
a filtration system for removing impurities, while retaining natural sugarcane compounds;
a UV light with thin film reactor to prevent yeast, bacteria growth or fermentation of cane juice;
a reverse osmosis unit to concentrate sugar while reducing evaporation time and energy consumption;
a selected use evaporator system;
a natural filtration system utilizing activated charcoal carbon and diatomaceous earth to modify color, odor, and flavor intensity post-evaporation; for quality and purity;
a recalibration unit for adjusting syrup density and consistency;
a quality control monitoring system ensuring uniformity across batches through routine calibration and inspection;
a closed-loop pasteurization system ensuring microbial stability without chemical preservatives;
a refrigerated storage system to maintain the syrups integrity and extend shelf life;
a combined CHP energy system utilizing biomass from bagasse pellets to generate electricity and thermal energy; and
a pasteurization element for temperatures above 180° F. to hot-packed or HPP and packaging system that preserves syrup integrity without synthetic additives or excessive refining.

22. The system of claim 21, wherein the evaporation system determines the final syrup characteristics through the use of (a) a vacuum boiling system at 185° F. for clear syrups with no caramelization, producing light-colored, mild-flavored syrup; (b) a flat pan (open pan) evaporator for molasses production exceeding 70+ Brix, creating a deeply caramelized, full-bodied syrup; and (c) a steam evaporator as a hybrid system, achieving controlled caramelization for medium-bodied syrups and higher volume production.

23. A method for producing various unrefined cane syrup while maintaining essential nutrients and minerals and allowing for customizable pure cane syrups ranging in characteristics from clear to molasses measuring against ICUMSA (International Commission for Uniformity Methods of Sugar Analysis) colorimetric reader-comprising the steps of (A) extracting sugarcane juice from fresh sugarcane using first cane crusher to macerate the sugar cane; (B) hyper-filtering the extracted juice-via a not non-centrifugal process-to preserve the natural juice while removing impurities and retaining polyphenols, amino acids, and antioxidants (minerals and vitamins); (C) treating the extracted juice with ultraviolet (UV) light thin film reactor to eliminate bacteria, yeast and microbes without using chemical agents; (D) using reverse osmosis to separate water content and reduce evaporation time and energy consumption while concentrating natural sugars; (E) refrigerating the concentrated juice (RO) for later evaporation; (F) evaporating the concentrated juice (RO) using one of three distinct evaporation methods, each producing unique syrup characteristics: (i) open flat pan evaporator, (ii) enclosed steam evaporator, or (iii) low pressure vacuum boiler; (G) using various filter aids with charcoal carbon and diatomaceous earth to achieve various color and purity levels without the use of bleaching agents; (H) adjusting Brix levels and density for final consistency by employing a recalibrating system; (I) ensuring batch consistency through routine quality control, calibration, and inspection before each production run; and (J) pasteurizing the final syrup above 180° F. and hot-packed using a closed-loop heating system to prevent microbial growth without altering its natural composition.

24. The method of claim 23 further comprising the step of (K) airtight sealing the final syrup for any and all appropriate packaging vessels and then stored in temperature-controlled silos to maintain freshness and extend shelf life.

25. The method of claim 23 further comprising the step of using a CHP system powered by biomass-derived bagasse pellets to sustain plant operations.

26. The method of claim 23 further comprising the step of high-pressure processing (HPP) to ensure microbial safety, extended shelf stability, and the preservation of natural nutrients.

27. The method of claim 23 wherein
(i) the open flat pan evaporator is continuously monitored and designed with direct heat exposure onto the flat, allowing for deeper flavor development from the caramelization of sugar as evaporation progresses;
(ii) the steam evaporator is an enclosed unit that accelerates production through precise thermal control; and
(iii) the vacuum boiler operates at lower temperature than traditional evaporators, maintaining a 185° F., using reduced atmospheric pressure to gently remove water from the syrup and allows for high density while preserving sugar characteristics and prevention of scorching the pans or over cooking process and an ingredient for a wide range of food and beverages to nutraceuticals.

28. Sugar cane products produced through the use of the system in claim 1, wherein the product retains its natural mineral and vitamins content due to the absence of centrifugal separation, high temperature heat and chemical bleaching, and wherein
(i) has a color and odor intensity are selectively reduced through activated charcoal filtration, allowing for a range of syrup variations from dark molasses to lighter, refined syrups;
(ii) maintains a low glycemic load and glycemic index, making it a healthier alternative to refined sugars and high-fructose corn syrup; and
(iii) is storable in temperature-controlled silos to ensure freshness and prevent crystallization.

29. Sugar cane products produced through the use of the system in claim 21, wherein the product retains its natural mineral and vitamins content due to the absence of centrifugal separation, high temperature heat and chemical bleaching and wherein
(i) has a color and odor intensity are selectively reduced through activated charcoal filtration, allowing for a range of syrup variations from dark molasses to lighter, refined syrups;
(ii) maintains a low glycemic load and glycemic index, making it a healthier alternative to refined sugars and high-fructose corn syrup; and
(iii) is storable in temperature-controlled silos to ensure freshness and prevent crystallization.

30. Sugar cane products produced through the method in claim 11, wherein the product retains its natural mineral and vitamins content due to the absence of centrifugal separation, high temperature heat and chemical bleaching and wherein
(i) has a color and odor intensity are selectively reduced through activated charcoal filtration, allowing for a range of syrup variations from dark molasses to lighter, refined syrups;
(ii) maintains a low glycemic load and low glycemic index, making it a healthier alternative to refined sugars and high-fructose com syrup; and
(iv) is storable in temperature-controlled silos to ensure freshness and prevent crystallization.

31. Sugar cane products produced through the method in claim 23, wherein the product retains its natural mineral and vitamins content due to the absence of centrifugal separation, high temperature heat and chemical bleaching and wherein
(i) has a color and odor intensity are selectively reduced through activated charcoal filtration, allowing for a range of syrup variations from dark molasses to lighter, refined syrups;
(ii) maintains a low glycemic load and glycemic index, making it a healthier alternative to refined sugars and high-fructose corn syrup; and
(iii) is storable in temperature-controlled silos to ensure freshness and prevent crystallization.

32. The sugar cane product of claim 31, wherein the syrups evaporation process is customized and allows (i) clear syrup production at 185° F. using a vacuum boiling system, preventing caramelization while maintaining a mild, delicate flavor, (ii) molasses formation exceeding 70 Brix using a flat pan (open pan) evaporator, producing a rich, deeply caramelized syrup, and (iii) balanced syrup production using a steam evaporator, creating a hybrid syrup with medium caramelization.
